(19) United States
(12) Patent Application Publication
(10) Pub. No.: US 2026/0271144 A1
(43) Pub. Date: Sep. 10, 2026

(54) ZERO CROSS DETECTION CIRCUIT FOR PHASE MEASUREMENT

(71) Applicant: Haier US Appliance Solutions, Inc., Wilmington, DE (US)

(72) Inventor: Nathaniel Lehrer, Louisville, KY (US)

(21) Appl. No.: 19/070,609

(22) Filed: Mar. 5, 2025

(51) Int. Cl. H05B 6/68; H05B 6/06

(52) U.S. Cl. CPC H05B 6/682; H05B 6/062; H05B 2213/05

(57) ABSTRACT

Induction heating systems and methods for induction cooking appliances are provided with inverters and resonant converters. Phase angle through the resonant tank is determined by measuring delay between respective zero crossings of applied voltage and induced current. A current measurement transducer outputs a negative voltage with respect to ground and a comparator capable of accepting an input voltage a few tenths of a volt below ground. An optimized current signal is used for phase only, resulting in reduced variation in phase measurement for different current magnitudes. One of a passive or active differentiator circuit connected to the resonant capacitors of the inverter connects to a clipping and scaling circuit. The clipping allows for an arbitrary gain for the current signal, while protecting the inputs of the comparator. The divider further reduces the voltage. The tank voltage signal initiates phase measurement by reducing the maximum signal presented to the comparator input.

### FIELD

Example aspects of the present disclosure relate generally to induction heating systems used, for instance, in induction cooking appliances, and more particularly to measuring a phase associated with an induction coil.

### BACKGROUND

Induction cooking appliance (e.g., induction cook-tops) heat conductive cookware by magnetic induction. An induction cooking appliance applies radio frequency current to a heating coil to generate a strong radio frequency magnetic field on the heating coil. When a conductive vessel, such as a pan, is placed over the heating coil, the magnetic field coupling from the heating coil generates eddy currents on the vessel, causing the vessel to increase in temperature, for resulting cooking effects for materials received in the corresponding receptacle (for example, pan).

### SUMMARY

Aspects and advantages of embodiments of the present disclosure will be set forth in part in the following description, or can be learned from the description, or can be learned through practice of the embodiments.

One example aspect of the present disclosure is directed to an induction heating system for an induction cooking appliance. The induction heating system includes an induction coil configured to inductively heat a load. The induction heating system further includes an inverter system configured to provide an alternating current to the induction coil. The induction heating system further includes a zero cross detection circuit for phase measurement that uses a current measurement transducer capable of outputting a negative voltage with respect to a measurement common voltage (ground) and a comparator capable of accepting an input voltage (few tenths of a volt below ground). The combination of such features allows a single supply system to create a phase signal using an input compared against ground.

Another example aspect of the present disclosure is directed to a method for determining the phase angle between the voltage applied and current through the resonant tank associated with an induction coil in an induction cooking appliance, accomplished by measuring the delay between the zero cross of applied voltage and the zero cross of the induced current. For example, in some aspects of some presently disclosed exemplary embodiments, a passive differentiator circuit connected to the resonant capacitors of the inverter connects to a clipping and scaling circuit wherein, the clipping allows for an arbitrary gain for the current signal while protecting the inputs of the comparator against over/under-voltage, and the divider further reduces the voltage if the forward voltage of the diodes is inadequate for protection, and additionally allows for the tank voltage signal to terminate/initiate the phase measurement by reducing the maximum signal presented to the comparator input facing the current signal.

Another example aspect of the present disclosure is directed to an induction cooking appliance. The induction cooking appliance includes a user interface comprising one or more user input devices. The induction cooking appliance further includes an induction heating system for an induction cooking appliance. The induction heating system includes an induction coil configured to inductively heat a load. The induction heating system further includes an inverter system configured to provide an alternating current to the induction coil.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure;

FIG. 2 provides a block diagram of an example induction heating system according to example embodiments of the present disclosure;

FIG. 3 depicts a schematic implementation of an example inverter system and an example induction coil of an example induction heating system according to example embodiments of the present disclosure;

FIG. 4 provides graphical representations of example signals of the induction heating system according to example embodiments of the present disclosure;

FIG. 5 provides exemplary graphic representations showing two exemplary input voltages relative to an exemplary reference voltage, and representing exemplary propagation delays;

FIG. 6 provides a circuit schematic of an exemplary embodiment of a presently disclosed phase measuring circuit and related and associated circuitry;

FIG. 7 graphically illustrates exemplary operations (per a simulation), showing representative differences in current signal generation and effects of propagation delay;

FIG. 8 graphically illustrates an enlarged portion of the graphic illustration of FIG. 7, focused on a selected representative time period of FIG. 7;

FIG. 9 provides a repeat of the circuit schematic of an exemplary embodiment of a presently disclosed phase measuring circuit of FIG. 6 and related and associated circuitry, and further designating selected signal measuring locations for graphic plots;

FIG. 10 graphically illustrates the graphic plots of the designated selected signal measuring locations as indicated in FIG. 9;

FIG. 11 graphically represents in chart format selected signals obtained per exemplary results of test confirmations for the presently disclosed subject matter; and

FIG. 12 graphically represents in plot format selected signals obtained per exemplary results of test confirmations for the presently disclosed subject matter, as represented in FIG. 11.

Repeat use of reference characters in the present specification and drawings is intended to represent the same and/or analogous features or elements or steps of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Induction cooking appliances may have induction heating systems configured to heat a load (e.g., a pan, cookware, vessel, etc.). Specifically, an induction heating system may include one or more coils (e.g., induction coils) operable to inductively heat one or more loads with a magnetic field and an inverter system operable to supply alternating current to the coil. Induction coil parameters such as the induction coil current phase are important in deciding a variety of operational characteristics/states of the induction heating system. For example, induction coil current phase measurements may be used to determine an output power of the induction coil or if a load is present on a coil of the induction cooking appliance.

In general, induction coil current phase with respect to the applied inverter voltage (e.g., induction coil current phase) may be determined based at least in part on a measured signal indicating the current to the induction coil. Some induction heating systems may determine the induction coil current phase with a unipolar measurement of the coil current. For example, current phase determined with unipolar measurements may only be sampled once per cycle, such as during the positive polarity state of the measured coil current. Further, unipolar measurements performed with passive input circuitry may lack symmetry to cancel imbalances in threshold levels, negatively impacting the accuracy of the determined value.

Example aspects of the present disclosure provide numerous technical effects and benefits. For instance, an induction heating system according to the present disclosure may provide for a cost effective, robust method for determining induction coil current phase. In addition, aspects of the present disclosure may provide for improved accuracy and precision in determining induction coil current phase.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

The present invention is about induction cooking devices with inverters/resonant converters, where the control of such systems relies on an estimation of the phase angle between the voltage applied and current through the resonant tank. The phase angle estimation is often accomplished by measuring the delay between the zero cross of applied voltage and the zero cross of the induced current. This presently disclosed method utilizes a current measurement transducer capable of outputting a negative voltage with respect to a measurement common voltage (ground) and a comparator capable of accepting an input voltage a few tenths of a volt below ground. The method utilizes current signal for phase only and optimizes with no regard for magnitude. Since the full-scale current signal is not designed to fit within the supply rail, a significantly higher gain is achieved. This output from the current sense circuit is presented to the phase comparator. A higher gain helps to minimize differences in overdrive and reduce variations in propagation delay across different comparators, and reduces variation in phase measurement for different current magnitudes. A passive differentiator circuit connected to the resonant capacitors of the inverter connects to a clipping and scaling circuit. The clipping allows for an arbitrary gain for the current signal, while protecting the inputs of the comparator against over/under-voltage and the divider further reduces the voltage if the forward voltage of the diodes is inadequate for protection. In addition, the tank voltage signal terminates (tank voltage polarity switches from Vcc to GND) and initiates the phase measurement by reducing the maximum signal presented to the comparator input facing the current signal. This presently disclosed combination allows a single supply system to create a phase signal using an input compared against the ground as opposed to a voltage generated using a bias network susceptible to resistor tolerances.

In resonant converters with an unknown load (such as induction cooking inverters), it is often necessary and useful to understand the phase angle between the voltage applied and current through the resonant tank. This is often accomplished by measuring the delay between the zero cross of applied voltage and the zero cross of the induced current.

The method presented here utilizes a current measurement transducer capable of outputting a negative voltage with respect to a measurement common voltage (ground) and a comparator capable of accepting an input voltage a few tenths of a volt below ground. This combination allows a single supply system to create a phase signal using an input compared against ground as opposed to a voltage generated using a bias network susceptible to resistor tolerances.

Current measurement circuits powered from a single supply often bias the output signal such that a current reading places the signal at mid\rail(Vcc/2). A maximum/minimum expected current generates a voltage near the rail/ground to maximize the utilizable voltage range.

Such sort of configuration relies on a bias network of resistors that are susceptible to tolerances and confines the slope of the current signal to whatever range allows for full-scale waveforms over the supply voltage. When trying to determine when the current passes through the zero point, an error budget consisting of variations in signal bias, reference bias, and slope interaction with a comparator (or similar device/circuit) will alter the phase reading. The last point is particularly complicated as overdrive behavior of comparators will alter switching speed (therefore, up to a point, the faster a signal passes through the reference voltage, the faster the comparator will switch its output). The propagation delay of the comparator is especially important as the overdrive differences can cause delays of several hundred nanoseconds, and at 50 kHz (typical low power inverter frequency), 56 ns is equal to one degree.

The solution presently disclosed herein relies on utilizing the current signal for phase only and optimizing with no regard for magnitude. In doing so, a significantly higher gain may be achieved and output from the current sense circuit and presented to the comparator. This higher gain will help to minimize differences in overdrive and therefore reduce variations in propagation delay, reducing variation in phase measurement for different current magnitudes.

Here, a passive differentiator circuit connected to the resonant capacitors of the inverter connects to a clipping and scaling circuit which serves multiple purposes. The clipping allows for an arbitrary gain for the current signal while protecting the inputs of the comparator against over/under-voltage. The divider further reduces the voltage if the forward voltage of the diodes is inadequate for protection, and additionally allows for the tank voltage signal to terminate, and to initiate the phase measurement by reducing the maximum signal presented to the comparator input facing the current signal.

Alternate embodiments could use other various current measurement techniques such as a current transformer. Other embodiments may utilize the tank voltage measured directly across the switching elements which could be compared with a static reference voltage, a scaled version of the bus voltage, or a peak detected version of itself.

The current comparator output may be fed into a microcontroller to trigger an input capture pin to determine phase.

Presently disclosed subject matter reduces delays due to comparator shortcomings, generating a more accurate phase result especially at high frequency operation in induction cooking environment. This allows for more comparators to be listed on the bill of materials (BOM) while still performing well (in other words, the disclosed approach achieves decreased sensitivity to individual comparator parameters).

Per some presently disclosed subject matter, some exemplary embodiments may include an induction cooktop inverter comprising zero cross detection circuit for phase measurement that uses a current measurement transducer capable of outputting a negative voltage with respect to a measurement common voltage (ground) and a comparator capable of accepting an input voltage (few tenths of a volt below ground). Such presently disclosed combination allows a single supply system to create a phase signal using an input compared against ground.

Per some other presently disclosed subject matter, some other exemplary embodiments may include a passive differentiator circuit connected to resonant capacitors of the inverter. The passive differentiator circuit can connect to a clipping and scaling circuit. The clipping functionality allows for an arbitrary gain for the current signal while protecting the inputs of the comparator against over/under-voltage. The divider (scaling) functionality further reduces the voltage if the forward voltage of the diodes is inadequate for protection, and additionally allows for the tank voltage signal to terminate/initiate the phase measurement by reducing the maximum signal presented to the comparator input facing the current signal.

Generally speaking, and as is known, a resonant converter is a type of power converter using a network of inductors and capacitors (referred to generally as a resonant tank) to achieve zero-voltage or zero-current switching. This is done by tuning the tank to resonate at a specific frequency, which causes the components to exchange energy in an oscillating manner.

Resonant converters can have many applications, in such as electronics or integrated circuits, frequently in high power applications where they reduce switching losses and switching noise. Different types of resonant converters include series, parallel, class E, zero voltage switching, and zero current switching. A series resonant converter connects the load in series with the resonant inductor and capacitor. An LLC resonant converter is a series-parallel topology, having wide load adaptability. For a resonant converter, the resonant tank's gain fluctuates based on the frequency and the load applied to its secondary side.

Referring now to the figures, example aspects of the present disclosure will be discussed in greater detail.

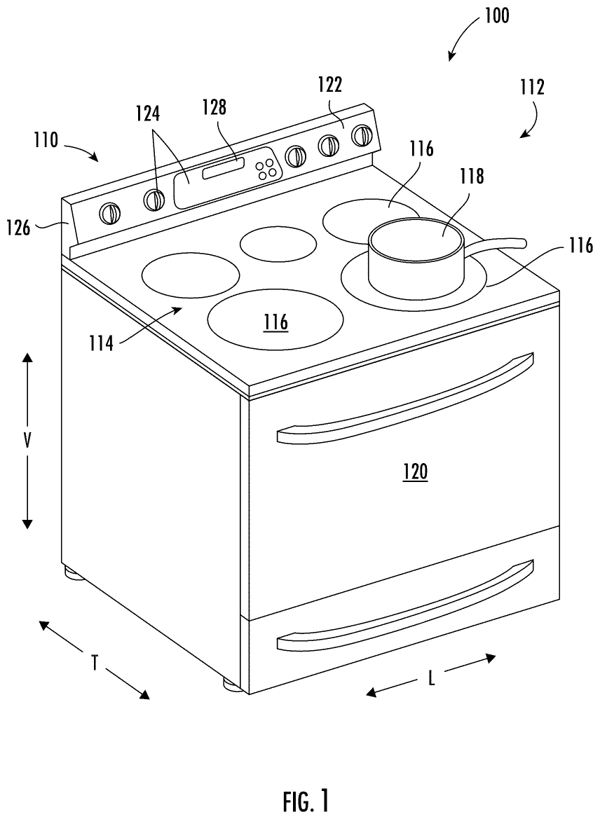

FIG. 1 depicts a perspective view of an induction cooking appliance 100. The induction cooking appliance include a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

Induction cooking appliance 100 generally defines a vertical direction V, a lateral direction L, and a transverse direction T, each of which is mutually perpendicular, such that an orthogonal coordinate system is generally defined. A cooking surface 114 of cooktop 112 includes one or more induction heating elements 116. As shown in FIG. 1, cooktop 112 may include a plurality of heating elements 116. The heating elements 116 are generally positioned at, e.g., on or proximate to, the cooking surface 114. For the embodiment depicted, the cooktop 112 includes five heating elements 116 spaced along cooking surface 114. However, in other embodiments, the cooktop 112 may include any other suitable shape, configuration, and/or number of heating elements 116. Each of the heating elements 116 may be induction heating elements 116 including induction coils, or cooktop 112 may include a combination of different types of heating elements 116. For example, in various embodiments, the cooktop 112 may include any other suitable type of heating elements 116 in addition to the induction heating element, such as a resistive heating element or gas burners, etc.

As shown in FIG. 1, a load 118 (e.g., cooking vessel), such as a pot, pan, or the like, may be placed on an induction heating element 116 to heat the load 118 and cook or heat food items placed in load 118. Induction cooking appliance 100 may also include a door 120 that permits access to a cooking chamber (not shown) of induction cooking appliance 100, e.g., for cooking or baking of food items therein. A user interface 122 (e.g., control panel) having user input devices 124 (e.g., user input devices) may permit a user to make selections for cooking of food items. Although shown on a backsplash or back panel 126 of induction cooking appliance 100, user interface 122 may be positioned in any suitable location. User input devices 124 may include buttons, knobs, and the like, as well as combinations thereof, and/or user input devices 124 may be implemented on a remote user interface device such as a smartphone, tablet, etc. As an example, a user may manipulate one or more user input devices 124 to select a temperature and/or a heat or power output for each heating element 116. The selected temperature or heat output of heating element 116 affects the heat transferred to load 118 placed on heating element 116. The user interface 122 may also include a display 128.

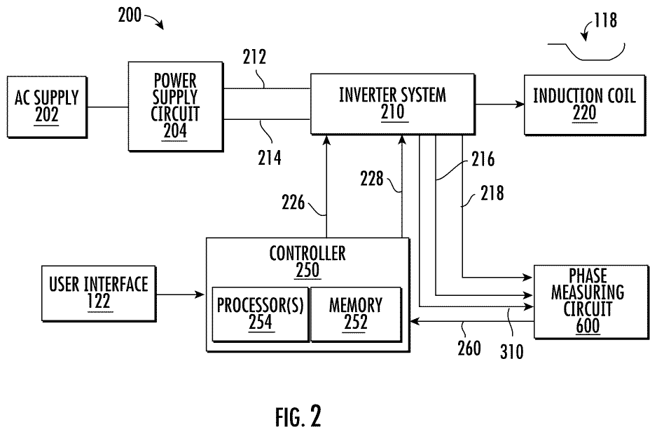

The induction cooking appliance 100 may include a control system for controlling one or more of the plurality of heating elements 116. Specifically, the control system may include a controller operably coupled to the user interface 122 (e.g., user input devices 124 and/or display 128). The controller may be operably coupled to each of the plurality of heating elements 116 for controlling a heating level each of the plurality of heating elements 116 in response to one or more user inputs received through the user interface 122 and user input devices 124. The controller may also provide output to the display 128, such as an indication of a selected power level, which heating element(s) 116 is or are activated, etc. Furthermore, as will be discussed in greater detail below, the control system may further be configured to control operation of an induction heating system 200 (FIG. 2) of the induction cooking appliance 100.

Referring now to FIG. 2, a block diagram of an induction heating system 200 for an induction cooking appliance is provided. While induction heating system 200 is discussed with reference to induction cooking appliance 100 of FIG. 1, those of ordinary skill in the art will understand that induction heating system 200 may be used in any suitable cooking system without deviating from the scope of the present disclosure.

Induction heating system 200 generally includes a power supply circuit 204. Power supply circuit 204 may receive AC power from an AC supply 202, which may provide conventional 60 Hz 120 or 240 volt AC supplied by utility companies. Power supply circuit 204 may include rectification circuitry for rectifying the power signal from the AC supply 202. In addition, power supply circuit 204 may include filtering and power factor correction circuitry to filter the rectified power signal. In some embodiments, AC supply 202 and/or power supply circuit 204 is configured to provide AC power to multiple induction coils 220.

Induction heating system 200 further includes an inverter system 210, such as a half-bridge resonant inverter system configured to provide an alternating current to induction coil 220 to inductively heat load 118. Inverter system 210 may receive power from power supply circuit 204. Specifically, the inverter system 210 may be operatively coupled to the power supply circuit 204 by a high-side path 212 and a low-side path 214. In some embodiments, high-side path 212 may be defined by a bus voltage, which is supplied to inverter system 210 by power supply circuit 204. Low-side path 214 may be defined by a ground supplied to low-side path 214 by power supply circuit 204. In some embodiments, inverter system 210 may include a variable frequency inverter.

Induction coil 220 may be defined as an induction heating element, such as induction heating element 116 as shown in FIG. 1. The induction coil 220, when supplied with alternating current, may inductively heat load 118 (e.g., pan, cooking vessel) or other object placed on, over, or near the coil 220. It will be understood that use of the term “load” herein is used merely as an example, and that term will generally include any object of a suitable type that is capable of being heated by an induction heating coil.

The switching frequency of the alternating current supplied to the induction coil 220 by inverter system 210 may be controlled by a controller 250. As shown, controller 250 may be operatively coupled to the inverter system 210 to control the output power of the induction coil 220 by controlling the switching frequency of inverter system 210. Controller 250 may include a microcontroller and/or gate driver circuitry to drive individual transistors or switching devices of the inverter system 210. In some embodiments, controller 250 may provide one or more switching signals 226, 228 to one or more gate drivers of the inverter system 210. For example, switching signal 226 may be provided to a high side gate driver and switching signal 228 may be provided to a low side gate driver.

As shown, controller 250 may include memory 252 and one or more processors 254 such as microprocessors, CPUs or the like, such as general or special purpose microprocessors operable to execute programming instructions or micro-control code associated with operation of induction cooking appliance 100. Memory 252 may represent random access memory such as DRAM, or read only memory such as ROM or FLASH. In one embodiment, the processor 254 executes programming instructions stored in memory 252. Memory 252 may be a separate component from controller 250 or may be included onboard controller 250.

In addition, controller 250 may be configured to determine one or more operational characteristics/states of induction heating system 200, such as an output power and/or a load presence of the induction coil, based at least in part on current phase signal 260 and/or the current phase. For instance, the current phase determined from current phase signal 260 may be defined as a measured phase value. The magnitude of the measured phase value may vary depending on the presence of a pan proximate induction coil 220. For example, the magnitude of the measured phase value may be greater when a pan is not present than when a pan is present. In addition, other characteristics of the load such as the size and type may be determined based on the measured phase value. Similarly, a measured output power of the induction coil 220 may be calculated by a controller, such as controller 250, using the measured phase value.

User interface 122 may also be operatively coupled to controller 250. In some embodiments, user interface 122 may allow a user to establish a desired power output of the induction heating coil 220 by, for example, selecting a power setting from a plurality of user selectable settings. In some embodiments, controller 250 may be configured to control the output power of the induction coil 220 by determining and/or adjusting the switching frequency of inverter system 210 based at least in part on the desired power setting set by the user, the measured output power, and/or the presence of the load.

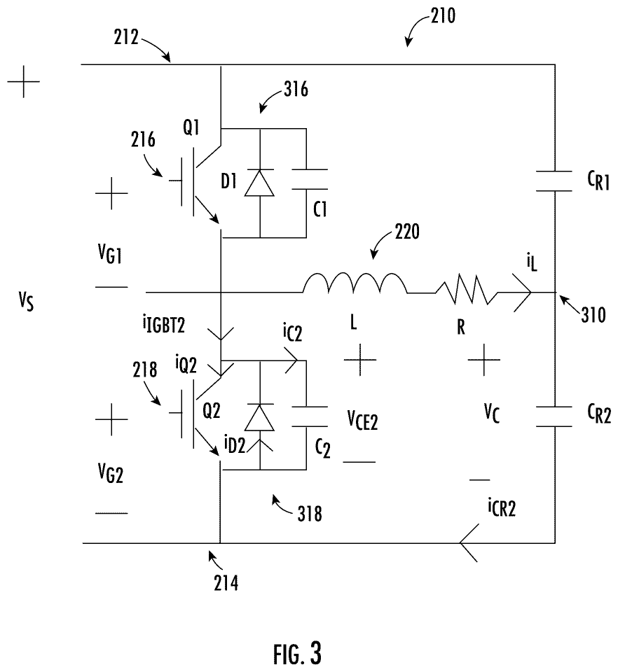

Referring now to FIG. 3, a circuit schematic depicting an example inverter system and induction coil is provided. Inverter system 210 and induction coil 220 may be implemented in any suitable induction heating system, such as induction heating system 200 of FIG. 2.

As shown in FIG. 3, inverter system 210 is configured to provide an alternating current (I_{L}) through the induction coil 220. The induction coil 220 and, if present, load 118 (shown in FIGS. 1 and 2) may be represented (e.g., modeled) in FIG. 3 as an inductor L (e.g., coil 220) and a resistor R (e.g., load 118). As illustrated in FIG. 3, L and R also represent the combined impedances of induction coil and load (e.g. pan).

As shown, induction coil 220 may be coupled to Q1 high-side switching device 316 and Q2 low-side switching device 318. Specifically, inverter system 210 may be a half-bridge resonant inverter system with switching devices 316, 318 on one side of the coil and resonant capacitors C_{R1}, C_{R2} on the other side of the coil. As previously described, inverter system 210 may include switching devices 316, 318 that provide alternating current (I_{L}) through the induction coil 220 at a desired frequency set by, for example, controller 250 (FIG. 2). Specifically, high-side switching device 316 may control (e.g., open or close) the flow of current based on high-side gate driver signal 216 provided for example by a high-side gate driver (not shown). Similarly, low-side switching device 318 may control (e.g., open or close) the flow of current based on low-side gate driver signal 218 provided by a low-side gate driver (not shown). As will be understood by those of ordinary skill in the art, gate driver signals 216, 218 may be determined based on respective switching signals 226, 228 (FIG. 2) provided to gate drivers (not shown) by a controller, such as controller 250 (FIG. 2).

In some embodiments, switching devices 316, 318 may be Insulated-Gate Bipolar Transistors (e.g., IGBTs). However, other suitable switching devices (e.g., MOSFETs) may be used without deviating from the scope of the present disclosure. Switching devices 316, 318 may be configured in parallel with capacitors (e.g., zero voltage switching capacitors) C₁ and C₂, respectively.

Inverter system 210 may be a resonant inverter system, such as a half-bridge resonant inverter system, with one or more resonant capacitors. As shown in FIG. 3, the one or more resonant capacitors may include a high-side resonant capacitor C_{R1} and a low-side resonant capacitor C_{R2}. As previously described with reference to FIG. 2, inverter system 210 may be operatively coupled to power supply circuit 204 (FIG. 2) by high-side path 212 and a low-side path 214. Induction coil 220 and resonant capacitors C_{R1} and C_{R2} may form a resonant tank. In some embodiments, a measurement node 310 may be defined within the resonant tank, such as between the two resonant capacitors (e.g., C_{R1} and C_{R2}). For example, measurement node 310 may be defined between the induction coil 220 and the one or more resonant capacitors (e.g., C_{R1} and C_{R2}). In some embodiments, further circuitry may be operable coupled to measurement node 310. Measurement node 310 in the example of FIG. 2 serves as an input to presently disclosed phase measuring circuit 600.

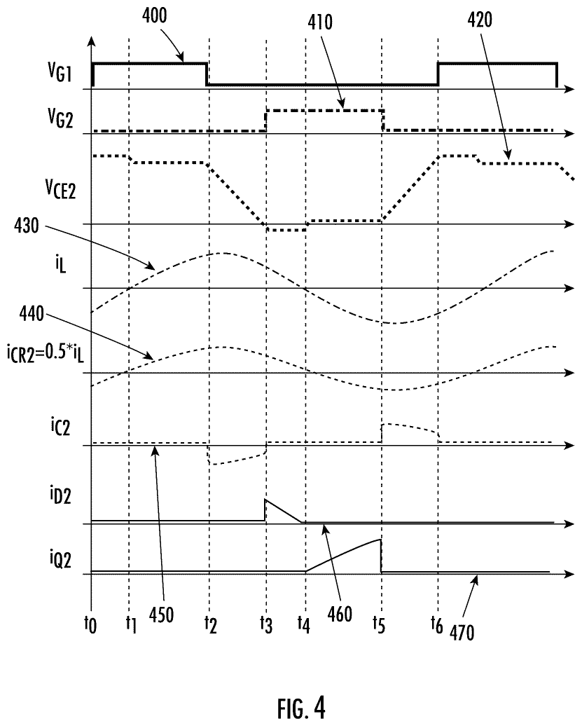

FIG. 4 depicts graphical representations of example signals of an induction heating system according to example embodiments of the present disclosure. Specifically, FIG. 4 includes example signals of induction heating system 200 shown in FIG. 2.

As shown in plots 400 and 410, respectively, an example first gate driver signal 400 (V_{G1}) may be compared with an example second gate driver signal 410 (V_{G2}).

Plot 420 shows an example voltage V_{CE2} across the output side of Q2 for low-side switching device 318.

Plot 430 shows example current (i_{L}) across inductor (L) load 220. Plot 440 shows current (i_{CR2}) of resonant capacitor C_{R2}, which is also ½ of current (i_{L}) across inductor (L) load 220. Considered another way, current (i_{L}) through inductor (L) load 220 is twice the current (i_{CR2}) of resonant capacitor C_{R2}, which is determined by the relationship i=C*(dv/dt).

Plots 450, 460, and 470, respectively, indicate current plots across C₂ and D2 of Q2, and across Q2 itself.

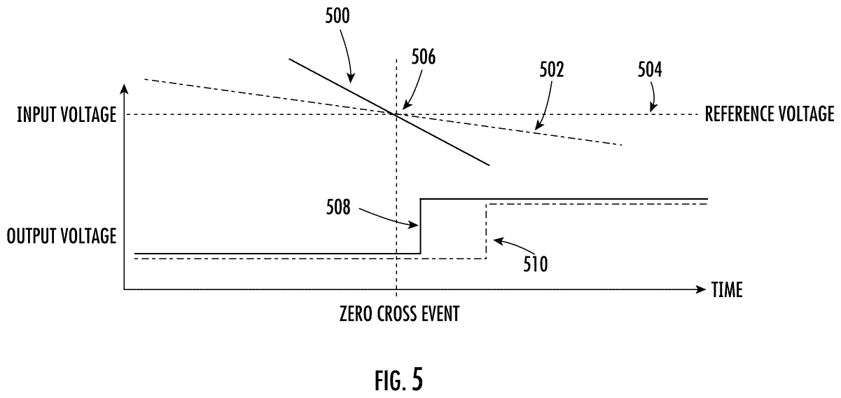

Referring again to problems addressed by presently disclosed subject matter, current measurement circuits powered from a single supply often bias the output signal such that a 0 current reading places the signal at mid-rail (Vcc/2), and a maximum/minimum expected current generates a voltage near the rail/ground to maximize the utilizable voltage range. Such sort of configuration relies on a bias network of resistors that are susceptible to tolerances and confines the slope of the current signal to whatever range allows for full-scale waveforms over the supply voltage. When trying to determine when the current passes through the zero point, an error budget consisting of variations in signal bias, reference bias, and slope interaction with a comparator (or similar device/circuit) will alter the phase reading. The last point is particularly complicated as overdrive behavior of comparators will alter switching speed. Therefore, up to a point, the faster a signal passes through the reference voltage, the faster the comparator will switch its output, as represented by the general FIG. 5 diagram. The propagation delay of the comparator is especially important as the overdrive differences can cause delays of several hundred nanoseconds, and at 50 kHz (typical low power inverter frequency), 56 ns is equal to one degree.

Per FIG. 5, such diagram generally shows two exemplary input voltages generally 500 and 502, which each cross an exemplary reference voltage at time point 506. However, a propagation delay is exhibited by output positive edges 508 and 510, respectively, at later times after time point 506.

The presently disclosed solution relies in some exemplary embodiments on utilizing the current signal for phase only and optimizing with no regard for magnitude. In doing so, a significantly higher gain may be achieved and output from the current sense circuit and presented to the comparator. This higher gain will help to minimize differences in overdrive and therefore reduce variations in propagation delay, reducing variation in phase measurement for different current magnitudes.

FIG. 6 provides a circuit schematic of an exemplary embodiment of a presently disclosed phase measuring circuit 600 and related and associated circuitry. As shown, for current sensing functionality, a passive differentiator circuit 602 connected to the resonant capacitors of the inverter (resonant capacitors C_{R1} and C_{R2} of FIG. 3) connects to a clipping circuit generally 604 and a scaling circuit generally 606 which serve multiple purposes. The clipping circuit 604 allows for an arbitrary gain for the current signal while protecting the inputs of the comparator generally 608 against over/under-voltage. The divider functionality of scaling circuit 606 further reduces the voltage if the forward voltage of the diodes of clipping circuit 604 is inadequate for protection, and additionally allows for the tank voltage signal to terminate, initiate the phase measurement by reducing the maximum signal presented to the comparator 608 input facing the current signal. Phase measuring circuit generally 600 may further optionally include a low pass filtering circuit generally 610, associated with the output of comparator 608, as illustrated per FIG. 6. It will be understood by those of ordinary skill in the art from the complete disclosure herewith that passive differentiator circuit 602 may alternatively be provided as an active circuit, such as for example using an op amp or other active circuit.

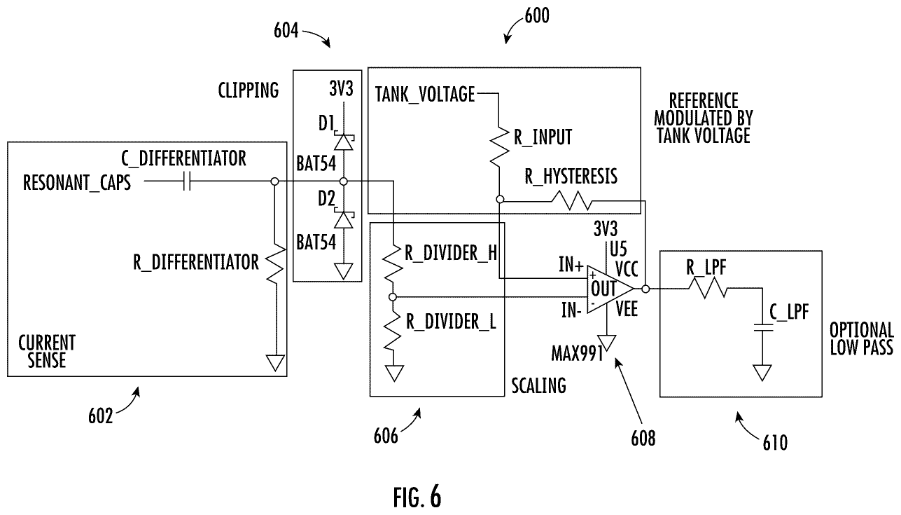

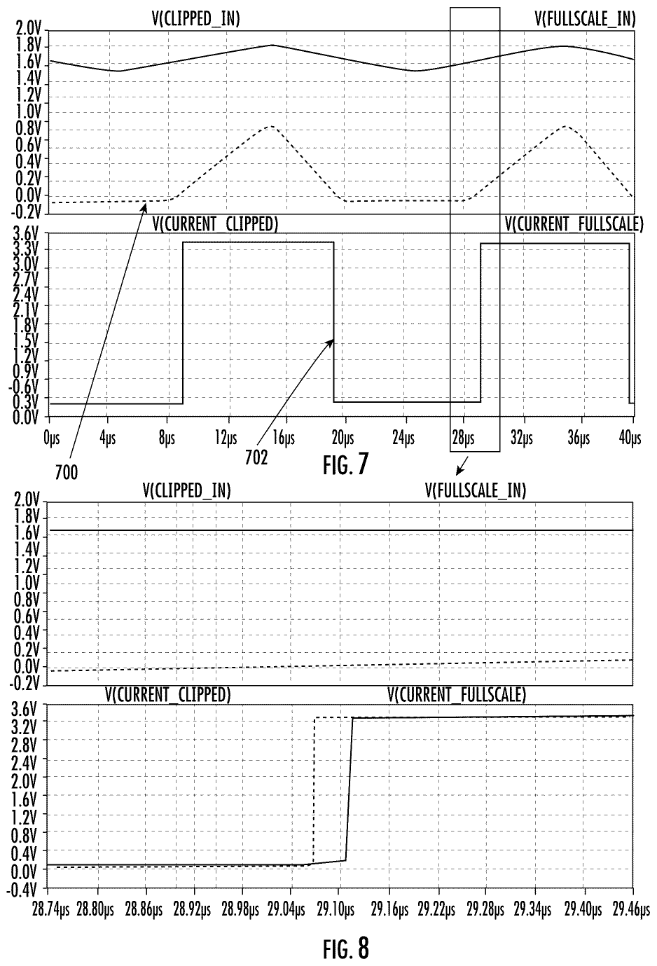

FIG. 7 graphically illustrates exemplary operations (per a simulation), showing representative differences in current signal generation and effects of propagation delay. With similar frequency roll-off/delay characteristic, the clipped input signal (plot 700; see plot 702 for comparator output signals) with larger amplitude sees less propagation delay in output switching compared to the smaller amplitude version. Both inputs cross their respective references at the same time, though a 50 ns delay (~1 degree) is captured here at the output, as illustrated by the enlarged graphic illustration of FIG. 8, focused on a time period between representative 28.74 μs and 29.46 μs. This effect can be even more appreciable with different comparators and when captured on bench set-ups.

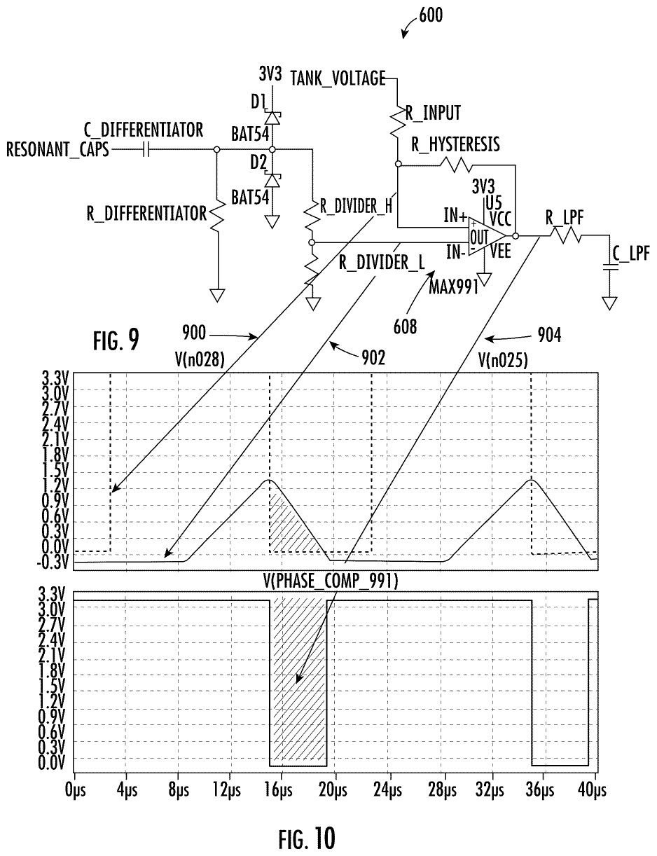

FIG. 9 primarily repeats circuit schematic of an exemplary embodiment of a presently disclosed phase measuring circuit 600 of FIG. 6 and related and associated circuitry, and further designates selected plots 900, 902, and 904, the results of which are graphically presented in FIG. 10. In particular, plots 900 and 902 relate to the respective inputs of comparator 608, while plot 904 relates to the output of comparator 608.

As will be understood by those of ordinary skill in the art from the complete disclosure herewith, the representative circuit schematics of FIGS. 6 and 9, represent that a phase pulse (active low) is initiated when a signal representative of the tank voltage polarity switches from Vcc to GND. At such time, the current is positive and decreasing. Once the current signal hits 0 volts, operation of the comparator 608 will terminate the phase pulse, and the active low duty cycle will be proportional to the phase (phase angel delay) of the system.

The effective functionality/performance of the divider features of the scaling circuitry generally 606 guarantees that the current signal will not falsely trip the comparator 608 when the tank voltage signal is high, as the current signal will be clipped at Vcc and then scaled by the divider ratio.

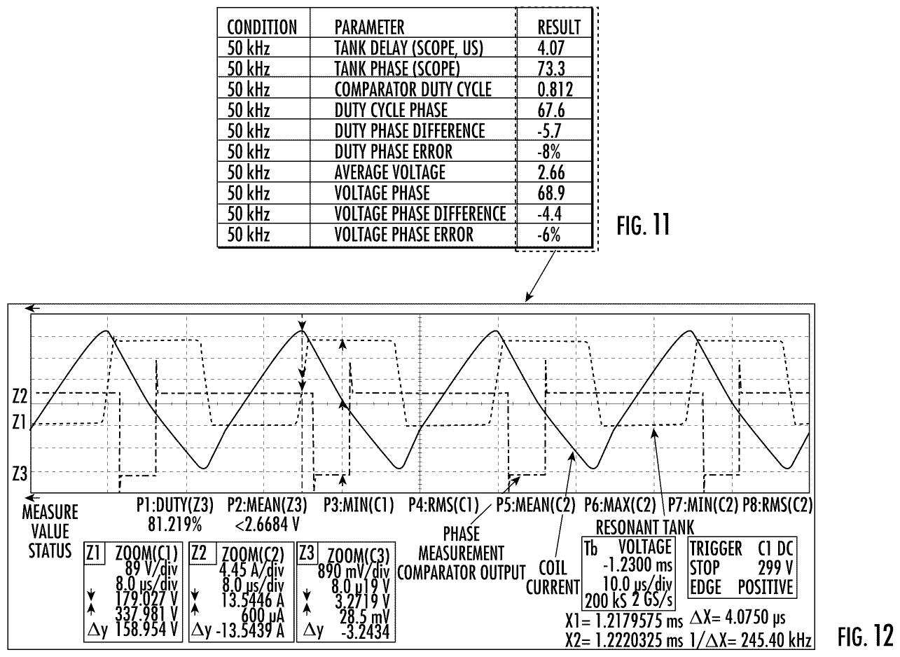

Confirmed functionality (via bench operation of circuit prototype) was obtained by directly measuring tank voltage and current. As will be understood, in some exemplary embodiments, a degree of some software compensation is preferable to account for any inherent system level timing error, particularly to account for any spread in error. FIGS. 11 and 12 graphically represent in chart and plot signal formats, exemplary results of such confirmations.

Confirmations were undertaken using various different comparators to compare performance robustness across different comparators. Such results showed the ability of the presently disclosed solutions to reduce the spread between measured phase angles from ~6 degrees to ~3 degrees using the presently disclosed subject matter when only swapping comparators.

Those of ordinary skill in the art should understand that various alternatives may be practiced without departing from the spirit and scope of the presently disclosed subject matter. For example, alternate embodiments may use other various initial current measurement techniques, such as a current transformer.

Other embodiments may utilize the tank voltage measured directly across the switching elements which could be compared with a static reference voltage, a scaled version of the bus voltage, or a peak detected version of itself.

Further, the current comparator output may be fed into a microcontroller to trigger an input capture pin to determine phase.

A different arrangement of resistors will yield similar results as well (for example, such as a single chain of resistors incorporating the divider and clipping diodes)

Although specific features of various embodiments may be shown in some drawings and not in others, this is for convenience only. In accordance with the principles of the present disclosure, any feature of a drawing can be referenced and/or claimed in combination with any feature of any other drawing.

One example aspect of the present disclosure is directed to an induction heating system for an induction cooking appliance. The disclosed exemplary induction heating system may include an induction coil configured to inductively heat a load, and an inverter system configured to provide an alternating current to the induction coil. Such exemplary induction heating system may also include a phase measuring circuit configured to determine a current zero cross detection phase signal indicative of a current phase of the induction coil based at least in part on using a current measurement transducer capable of outputting a negative voltage with respect to a measurement common voltage.

Another example aspect of the present disclosure is directed to a method for determining a current phase of an induction coil in an induction cooking appliance. Such exemplary method may preferably comprise determining a current zero cross detection phase signal indicative of a current phase of the induction coil based at least in part on using a current measurement transducer capable of outputting a negative voltage with respect to a measurement common voltage; and determining the current phase of the induction coil based at least in part on the current zero cross detection phase signal.

Yet another example aspect of the present disclosure is directed to an induction cooking appliance. The induction cooking appliance includes a user interface comprising one or more user input devices; and an induction heating system for an induction cooking appliance. The induction heating system includes an induction coil configured to inductively heat a load; an inverter system configured to provide an alternating current to the induction coil; and a phase measuring circuit. Such exemplary phase measuring circuit is configured to determine a current zero cross detection phase signal indicative of a current phase of the induction coil based at least in part on using a current measurement transducer capable of outputting a negative voltage with respect to a measurement common voltage. Those of ordinary skill in the art will understand from the complete disclosure herewith that variations may be practiced, for example, to the measuring circuit. Such features may be variously reconfigured, for example, to use a dual supply system (i.e. have a positive and negative voltage rail some voltage above and below ground, respectively).

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An induction heating system for an induction cooking appliance, comprising:
an induction coil configured to inductively heat a load;
an inverter system configured to provide an alternating current to the induction coil; and
a phase measuring circuit configured to determine a current zero cross detection phase signal indicative of a current phase of the induction coil based at least in part on using a current measurement transducer capable of outputting a negative voltage with respect to a measurement common voltage.

2. The induction heating system of claim 1, wherein the common voltage is ground and the phase measuring circuit is further configured for using a comparator capable of accepting a negative input voltage, which allows a single supply system to create a current phase signal using an input compared against ground.

3. The induction heating system of claim 2, wherein:
the inverter system comprises a pair of resonant capacitors;
the comparator comprises one of a passive or active differentiator circuit connected to the resonant capacitors of the inverter; and
the phase measuring circuit is further configured for connection to a clipping and scaling circuit to protect inputs of the comparator by reducing the input voltage and by reducing the maximum signal presented to the comparator input facing the current signal.

4. The induction heating system of claim 1, wherein the phase measuring circuit further comprises a low pass filtering circuit configured to filter the current zero cross detection phase signal.

5. The induction heating system of claim 1, further comprising a sensing component configured to determine a current measurement signal indicative of current to the induction coil.

6. The induction heating system of claim 5, wherein:
the inverter system comprises a pair of resonant capacitors; and
the sensing component comprises a passive network circuit connected to the resonant capacitors of the inverter.

7. The induction heating system of claim 5, wherein the current measurement signal is determined based at least in part on a voltage signal indicative of a voltage at a node defined between the induction coil and one or more resonant capacitors of the inverter system.

8. The induction heating system of claim 1, further comprising:
a controller configured to determine an output power of the induction coil based at least in part on the current zero cross detection phase signal.

9. The induction heating system of claim 1, further comprising:
a controller configured to determine a load presence of the induction coil based at least in part on the current zero cross detection phase signal.

10. A method for determining a current phase of an induction coil in an induction cooking appliance, the method comprising:
determining a current zero cross detection phase signal indicative of a current phase of the induction coil based at least in part on using a current measurement transducer capable of outputting a negative voltage with respect to a measurement common voltage; and
determining the current phase of the induction coil based at least in part on the current zero cross detection phase signal.

11. The method of claim 10, wherein:
the common voltage is ground; and
the method further comprises using a comparator capable of accepting a negative input voltage, which allows a single supply system to create to determine the current phase of the induction coil using an input compared against ground.

12. The method of claim 11, wherein:
a pair of resonant capacitors are associated with the induction coil;
the comparator comprises one of a passive or active differentiator circuit connected to the resonant capacitors of the inverter; and
the current zero cross detection phase signal is clipped and scaled to protect inputs of the comparator by reducing the input voltage and by reducing the maximum signal presented to the comparator input facing the current signal.

13. The method of claim 10, further comprising:
filtering, by a low pass filtering circuit, the current zero cross detection phase signal.

14. The method of claim 10, further comprising:
determining, by a sensing component, a current measurement signal indicative of current to the induction coil.

15. The method of claim 14, wherein:
a pair of resonant capacitors are associated with the induction coil; and
the sensing component comprises a passive network circuit operatively coupled to a node defined between the two resonant capacitors and the induction coil.

16. The method of claim 10, further comprising:
determining one of an output power or a load presence of the induction coil based at least in part on the current phase based on the current zero cross detection phase signal.

17. An induction cooking appliance, comprising:
a user interface comprising one or more user input devices; and
an induction heating system for an induction cooking appliance, comprising:
an induction coil configured to inductively heat a load;
an inverter system configured to provide an alternating current to the induction coil; and
a phase measuring circuit configured to determine a current zero cross detection phase signal indicative of a current phase of the induction coil based at least in part on using a current measurement transducer capable of outputting a negative voltage with respect to a measurement common voltage.

18. The induction cooking appliance of claim 17, wherein the common voltage is ground and the phase measuring circuit is further configured for using a comparator capable of accepting a negative input voltage, which allows a single supply system to create a current phase signal using an input compared against ground.

19. The induction cooking appliance of claim 18, wherein:
the inverter system comprises a pair of resonant capacitors;
the comparator comprises one of a passive or active differentiator circuit connected to the resonant capacitors of the inverter; and
the phase measuring circuit is further configured for connection to a clipping and scaling circuit to protect inputs of the comparator by reducing the input voltage and by reducing the maximum signal presented to the comparator input facing the current signal.

20. The induction cooking appliance of claim 17, wherein the phase measuring circuit further comprises a low pass filtering circuit configured to filter the current zero cross detection phase signal.
